(19) United States
(12) Patent Application Publication
(10) Pub. No.: US 2009/0244170 A1
(43) Pub. Date: Oct. 1, 2009

(54) INKJET PRINTER

(76) Inventor: Katsuo MIKASHIMA, Wakayama-shi (JP)

Correspondence Address: FULBRIGHT & JAWORSKI, LLP, 666 FIFTH AVE, NEW YORK, NY, 10103-3198, US

(21) Appl. No.: 12/401,719

(22) Filed: Mar. 11, 2009

(30) Foreign Application Priority Data
Mar. 26, 2008 (JP) 2008-081493

(51) Int. Cl. B41J 2/165

(52) U.S. Cl. 347/31; 347/32

(57) ABSTRACT

An inkjet printer comprising a printhead for allowing ink to be ejected from a nozzle portion to form an image on a recording medium, a cap member switchable between a sealing position for sealing nozzle surfaces of the nozzle portion and a free position where the cap member is moved away from the nozzle surfaces, and a closing mechanism for closing an opening of the cap member located in the free position.

### BACKGROUND OF THE INVENTION

1. Field of the Invention

The present invention relates to an inkjet printer comprising a printhead for allowing ink to be ejected from a nozzle portion to form an image on a recording medium, and a cap member switchable between a sealing position for sealing nozzle surfaces of the nozzle portion and a free position where the cap member is moved away from the nozzle surfaces.

2. Description of the Related Art

An example of the inkjet printer of the above-noted type is shown in Japanese Unexamined Patent Application Publication No. 2007-196482 (referred to as JP 2007-196482 hereinafter). According to this publication, the inkjet printer comprises a cap member capable of sealing the nozzle surfaces when the printhead is positioned at a non-printing area, and a mechanism for drawing ink absorbed in a porous ink absorber disposed in the cap member by a pump to discharge the ink to a waste ink tank. It is further described in JP 2007-196482 that the interior of the nozzle portion can be effectively prevented from being dried since an ink solvent is evaporated from the ink that is naturally retained in the ink absorber and directed into a space surrounded by the nozzle surfaces and the cap member to humidify the space.

However, with the inkjet printer disclosed in JP 2007-196482, the ink solvent is evaporated into ambient air extensively from the ink absorber disposed in the cap member, particularly when a printing operation is continuously performed for a long period of time in circumstances where a room is dried or kept at a high temperature (including high-temperature conditions in the casing of the printer). Thus, a hard and dry ink layer is formed on the surface of the ink absorber to lower the ability of the ink absorber to absorb the ink and the ability to seal the nozzle surfaces, as a result of which the interior of the nozzle portion may not effectively be prevented from being dried.

The present invention has been made having regard to the above-noted disadvantages inherent in the conventional inkjet printer, and its object is to provide an inkjet printer for easily preventing the interior of the nozzle portion being dried even under the severe use conditions where the printing operation is continuously performed for a long period of time in circumstances where a room is dried or kept at a high temperature.

### SUMMARY OF THE INVENTION

The first characteristic feature of the inkjet printer in accordance with the present invention lies in comprising a printhead for allowing ink to be ejected from a nozzle portion to form an image on a recording medium, a cap member switchable between a sealing position for sealing nozzle surfaces of the nozzle portion and a free position where the cap member is moved away from the nozzle surfaces, and a closing mechanism for closing an opening of the cap member located in the free position.

With the inkjet printer having the first characteristic feature of the present invention, the opening of the cap member is closed in the free position where the cap member is moved away from the nozzle surfaces during the printing operation, for example. Thus, water or the ink solvent is not easily evaporated from the cap member even under the severe use conditions where the printing operation is continuously performed in a dried room for a long period of time, as a result of which the ability of the cap member to prevent dryness is maintained to easily restrain the nozzle portion from being dried and clogged.

Another characteristic feature of the inkjet printer in accordance with the present invention lies in the closing mechanism including a cover member for closing the opening of the cap member, and a movement operation mechanism for moving the cover member between a closing position where the opening of the cap member is closed and a release position where the opening of the cap member is exposed in response to switching operations of the cap member between the sealing position and the free position.

With this arrangement, the condition in which the opening of the cap member is closed by the cover member is automatically maintained by the movement operation mechanism while the cap member is in the free position. Thus, the ability of the cap member to prevent dryness is retained more reliably.

A further characteristic feature of the present invention lies in the closing mechanism including a cover member provided in a casing of the inkjet printer, and a movement operation mechanism for moving the cap member between a closing position where the opening of the cap member is closed by the cover member and a release position where the opening of the cap member is exposed in response to switching operations of the cap member between the sealing position and the free position.

With this arrangement, the condition in which the opening of the cap member is closed by the cover member is automatically maintained by the movement operation mechanism while the cap member is in the free position. Thus, the ability of the cap member to prevent dryness is retained more reliably.

A still further characteristic feature of the present invention lies in that an ink absorber is provided in an inner surface of the cap member, and the cover member has a closing surface to be pressed on the ink absorber.

With this arrangement, the surface of the ink absorber for absorbing the ink overflowed from the nozzle portion or the ink adhered to the peripheries of a tip end of the nozzle portion is sealed by the closing surface of the cover member and shielded from ambient air, thereby reliably preventing evaporation of water or the ink solvent from the ink absorber. As a result, a hardened layer of the ink is more unlikely to be formed on the surface of the ink absorber.

A still further characteristic feature of the present invention lies in that a humidifier mechanism is provided in an inner surface of the cover member for humidifying the ink absorber.

With this arrangement, since it is possible to maintain the ink absorber disposed in the cap member in a wet condition, a hardened layer of the ink is more unlikely to be formed on the surface of the ink absorber.

### BRIEF DESCRIPTION OF THE DRAWINGS

FIG. 1 is a perspective view of a principal arrangement of a printing apparatus;

FIG. 2 is a side view of the principal arrangement of the printing apparatus in vertical section;

FIG. 3 is a top plan view showing an operation line of a printhead;

FIG. 4 is a perspective view of a carriage printhead;

FIG. 5 is a side view of the carriage printhead;

FIG. 6 is a perspective view of a sensor unit;

FIG. 7 is a schematic side view showing a nozzle surfaces control system (a sealing mechanism and a closing mechanism); and

FIG. 8 is a schematic side view showing a modification of the nozzle surfaces control system.

### DETAILED DESCRIPTION OF THE PREFERRED EMBODIMENT

Preferred embodiments of an inkjet printer in accordance with the present invention will be described in detail hereinafter in reference to the accompanying drawings.

### [Overall Structure]

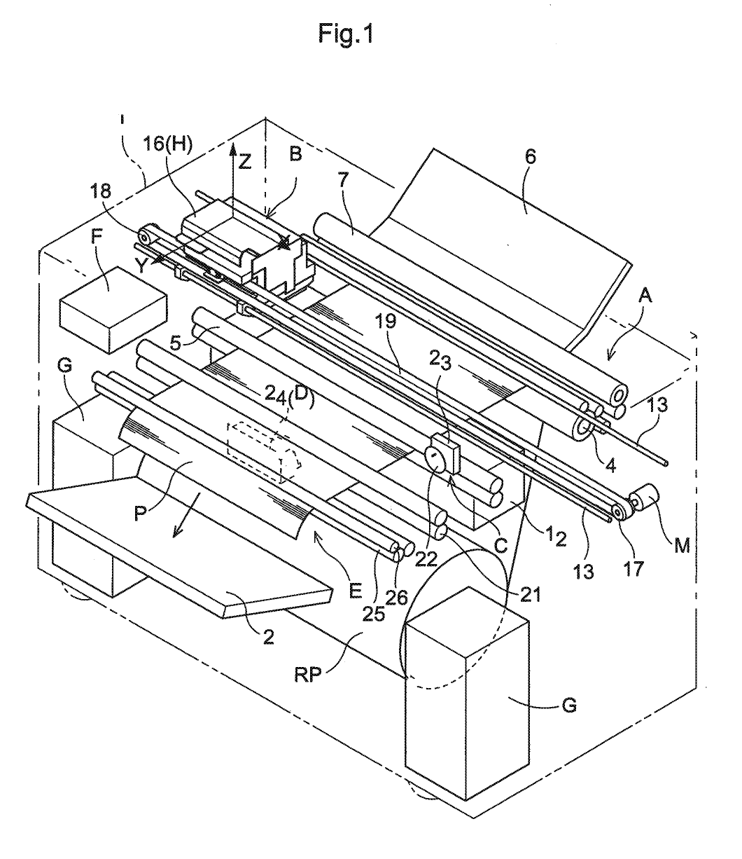

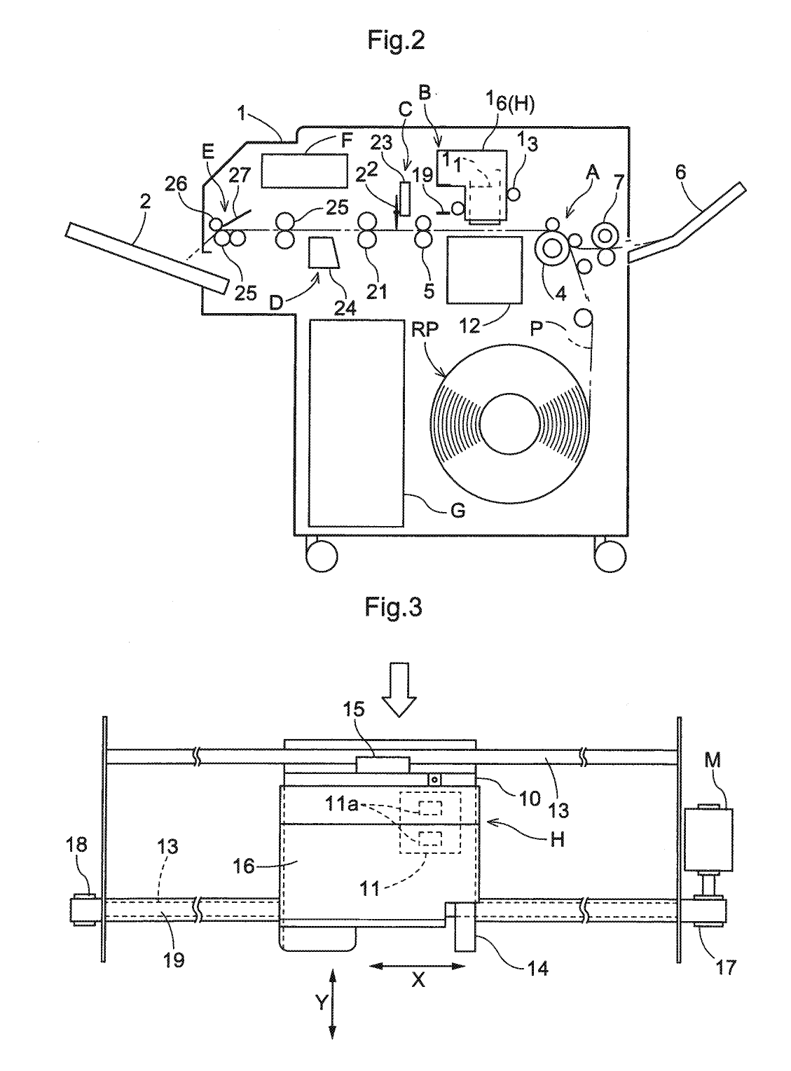

An inkjet printer shown in FIGS. 1 and 2 is adapted to feed print paper P drawn out of a roll of print paper RP acting as a recording medium through a transporting mechanism A to a printing section B and print image information at the printing section B. The inkjet printer comprises a cutting section C for cutting off a portion of the print paper P in which the printing is completed, a back side printing section D for performing the printing on the back side of the print paper P, a decurl section E for eliminating curl of the print paper P, and a transporting system for discharging the print paper P on a paper discharge tray 2 provided in the outside of a casing 1. The casing 1 also includes in its interior a control unit F, an ink reservoir G, and the like.

The transporting mechanism A includes transporting rollers 4 and 5 of a pressure-contact type provided upstream and downstream of the printing section B in a transporting direction, respectively. The transporting mechanism A is also adapted to take in a cut sheet set in a manual-bypass tray 6 provided in the outside of the casing 1 through a feeding roller 7 of a pressure-contact type to feed the sheet to the printing section B.

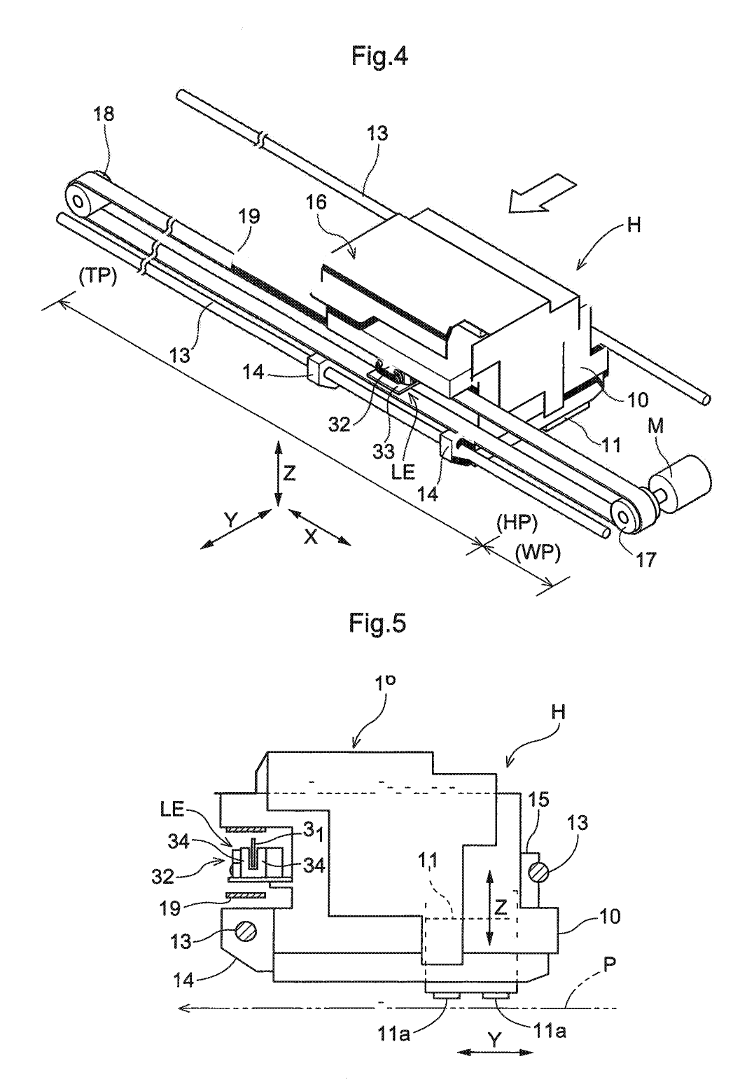

As shown in FIGS. 1 to 5, the printing section B includes a printhead H reciprocating in a main scanning direction (X-axis direction), and a paper guide 12 in the form of a suction unit arranged in a position opposed to the printhead H across a transporting path of the print paper P.

The printhead H includes a carriage 10, an ink ejector unit 11 connected to the carriage 10 for ejecting ink on the print paper P to print information, and a carriage cover 16 for covering above the carriage 10. The paper guide 12 in the form of the suction unit accommodates an electric fan (not shown) for drawing air from numerous openings formed in a top surface of the case-like unit and directing it downward.

The cutting section C includes a transporting roller 21 for transporting the print paper P in a pressure-contact condition, a disk-shaped cutter 22 for cutting the print paper P, and an operating mechanism 23 for reciprocating the disk-shaped cutter 22 in the main scanning direction X.

The back side printing section D includes a printing head 24 for printing information on the back side of the print paper P. In order to eliminate the curl of the print paper P, the decurl section E includes a single transporting roller 25 for curling the print paper P in a direction opposite to a winding direction of the roll of print paper RP for transportation of the print paper, a single straightening roller 26 arranged in a position opposed to the transporting roller 25, and a plurality of guide plates 27. The decurl section E includes an electric motor that is not shown for driving the transporting roller 25, whereby the curl of the print paper P is eliminated when the transporting roller 25 and the straightening roller 26 pressure-contact and transport the print paper P.

A plurality of ink cartridges (not shown) are set in the ink reservoir G. The ink is directed from the ink reservoir G to an intermediate tank (not shown), and fed to the printhead H through a tube from the intermediate tank.

### [Print Process Mode]

In time of printing, a tip end portion of the print paper P is fed to a lower position of the printing section B by the transporting mechanism A and stopped. In this condition, negative pressure received from the paper guide 12 in the form of the suction unit is applied to the back side of the print paper P, thereby adsorbing the print paper P on a top surface of the paper guide 12 to keep the print paper P in a flat condition. The ink is ejected from the ink ejector unit 11 to the print paper P in such a condition while the printhead H is reciprocated in the main scanning direction (X-axis direction) to print image information or the like.

More particularly, the ink is ejected from the ink ejector unit 11 while the printhead H is moved in the main scanning direction X from a home position HP toward a turning point TP to perform printing. As the printhead H reaches the turning point TP, the transporting mechanism A transports the print paper P in a sub-scanning direction (Y-axis direction) by a predetermined distance. After the print paper is transported, the ink is ejected from the ink ejector unit 11 while the printhead H is moved from the turning point TP to the home position HP to print image information on the print paper P.

As the print paper P on which the information is printed by the reciprocating movement of the printhead H is transported to the cutting section C, transportation of the paper is suspended when a cutting position of the print paper P reaches a cutting position of the disk-shaped cutter 22. In this suspended state, the operating mechanism 23 moves the disk-shaped cutter 22 in the main scanning direction, thereby cutting the print paper P into a printing size.

Next, information for identifying an order is printed on the cut print paper P by the printing head 24 of the back side printing section D. Subsequently, the cut print paper P is fed to the transporting roller 25, the straightening roller 26, and the guide plates 27 of the decurl section E, where curl is eliminated, and then discharged on a top surface of the paper discharge tray 2.

### [Detailed Arrangement of the Printing Section]

A pair of guide rods 13 each having a circular section is arranged in the printing section B parallel to the main scanning direction. The carriage 10 is slidably supported to the pair of guide rods 13, and the ink ejector unit 11 is connected to a bottom surface of the carriage 10. Nozzle surfaces 11a having numerous ejecting nozzles formed thereon are provided in a bottom surface of the ink ejector unit 11. According to the present embodiment, the two nozzle surfaces 11a are provided to be spaced from each other in the sub-scanning direction (Y-axis direction).

A pair of sliding guides 14 are provided in one side surface of the carriage 10 in the sub-scanning direction, each of which has a circular opening to fit on one of the guide rods 13. A sliding block 15 is provided in the other side surface of the carriage 10 which has a recess formed therein to engage with the other of the guide rods 13. The carriage cover 16 is mounted above the carriage 10.

A driving belt 19 of a timing belt type that is wound around a driving pulley 17 and an idling pulley 18 is arranged at a side of the carriage 10 along the main scanning direction. The driving belt 19 is connected to the carriage 10 to allow a rotational driving force to be transmitted to the driving pulley 17 through a driving motor M.

A band-shaped linear strip 31 acting as a linear encoder LE for determining the position of the printhead H in the main scanning direction is fixed to the casing 1 parallel to the main scanning direction in the vicinity of the printhead H. A sensor unit 32 is supported to the carriage 10 of the printhead H through a substrate 33 for optically obtaining scale information of the linear strip 31.

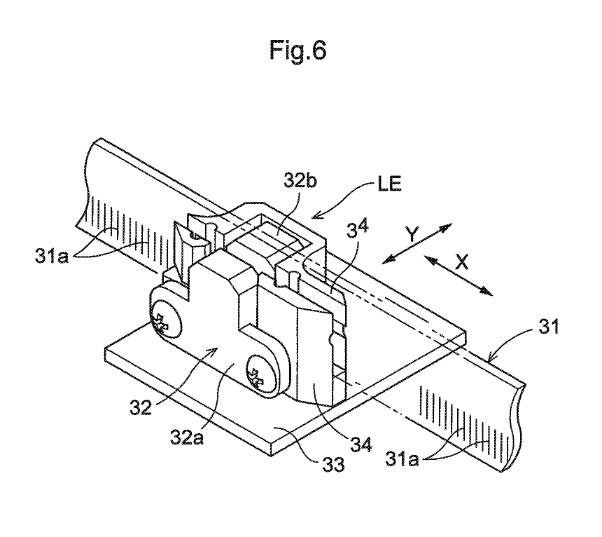

As shown in FIG. 6, the linear strip 31 has scale marks 31a in the form of bar codes printed at predetermined intervals on a band-shaped transparent member made of resin, for example. The substrate 33 includes a pair of wall members 34 projecting therefrom to be positioned close to both the front side and back side of the linear strip 31 in a thickness direction (which agrees with the sub-scanning direction). The sensor unit 32 is fixed to the wall members 34. The sensor unit 32 is a photo-interrupter type including a light source module 32a and a photo sensor module 32b opposed to the light source module.

The linear encoder LE is an increment type for identifying the position of the printhead H in the main scanning direction by counting the number of the scale marks 31a when the printhead H is moved. The driving pulley 17, the idling pulley 18, the driving belt 19, and the driving motor M constitute a moving mechanism for the printhead H.

The control unit F is adapted to obtain information about images or letters to be printed, control the transporting mechanism A, control the driving motor M based on a signal received form the linear encoder LE, and synchronize with activation of the driving motor M to control a driving mechanism that is built in the ink ejector unit 11, thereby allowing the ink to be ejected from the ejecting nozzles formed on the nozzle surfaces 11a to print the information.

In time of printing, the position of the printhead H in the main scanning direction is identified by the information received from the linear encoder LE in reference to the home position H of the printhead H. Further, the control unit F is adapted to control the operating mechanism 23 of the cutting section C, control the printing head 24 of the back side printing section D, and control the decurl section E.

### [Nozzle Surfaces Control System]

As a nozzle surfaces control system for maintaining the nozzle surfaces 11a of the printhead H in a good condition, a sealing mechanism S is provided for sealing the nozzle surfaces 11a in order to prevent the nozzle surfaces 11a from being dried while the printhead H is stopped at a waiting position WP defined outwardly of the home position HP.

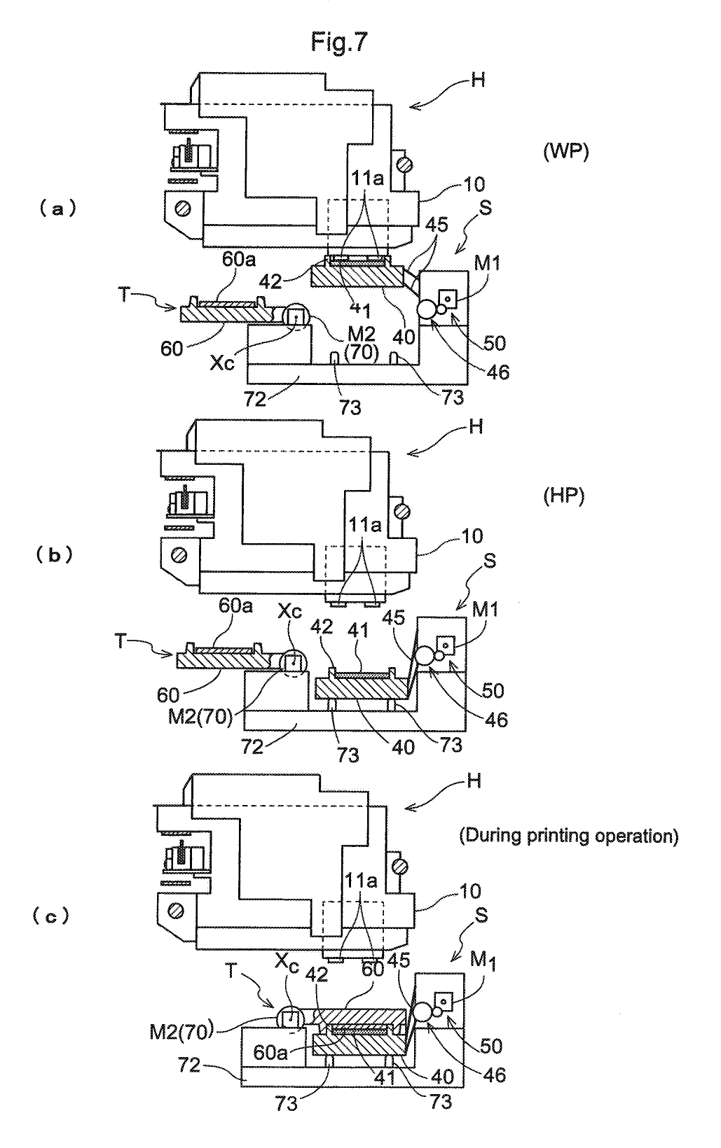

As shown in FIG. 7, the sealing mechanism S includes a cap member 40 for fitting to the nozzle surfaces 11a to seal the nozzle surfaces 11a from ambient air, and a switching mechanism 50 for switching the cap member 40 between a sealing position in which the cap member 40 is fitted to the nozzle surfaces 11a and a free position in which the cam member 40 is moved away from the nozzle surfaces 11a. FIG. 7(a) shows the sealing position in which the cap member 40 seals the nozzle surfaces 11a while FIG. 7(b) and FIG. 7(c) show the free position in which the cam member 40 is moved away from the nozzle surfaces 11a.

Here, the switching mechanism 50 includes a four-point link mechanism having at least two link arms 45 extending from one side surface of the cap member 40, and a driving mechanism for pivotably moving one of the link arms 45. The driving mechanism includes a motor M1, and a reduction transmission mechanism 46 for converting a driving force of the motor M1 to pivotal movement of the link arm 45.

The cap member 40 has a generally rectangular shape and includes an ink absorber 41 made of a flexible porous material provided on a top surface thereof in the form of a mat, and a sealing member 42 made of an elastic material provided outwardly of the ink absorber 41 to surround the ink absorber like a low wall.

When the cap member 40 is maintained in the sealing position by the link arms 45 of the switching mechanism 50, the ink absorber 41 is pressed on the two nozzle surfaces 11a. At the same time, the sealing member 42 is brought in tight contact with the flat bottom surface of the ink ejector unit 11 to shield the nozzle surfaces 11a and the sealing member 42 from ambient air.

The nozzle surfaces control system further includes a closing mechanism T for closing an opening of the cap member 40 in the free position in which the cap member 40 is moved away from the nozzle surfaces 11a. The closing mechanism T includes a cover member 60 for closing the interior (one example of the opening) of the sealing member 42 of the cap member 40, and a movement operation mechanism 70 for moving the cover member 60 between a closing position to close the opening of the cap member 40 and a releasing position to expose the opening of the cap member 40 in response to the switching operation of the cap member 40 between the sealing position and the free position.

The cover member 60 is supported at a side portion thereof to be pivotable about a horizontal axis Xc, while the movement operation mechanism 70 includes a driving mechanism having a motor M2 and the like for pivotably moving the cover member 60. FIG. 7(a) and FIG. 7(b) show the cover member 60 in the release position, while FIG. 7(c) shows the cover member 60 in the closing position. In the closing position, a flat closing surface 60a formed on the inner surface of the cover member 60 is brought to tight contact with the surface of the ink absorber 41 to prevent the ink adhered to the surface of the ink absorber 41 from being hardened and part of components of the ink from being volatilized and evaporated. The closing surface 60a may be made of non-porous resin, for example. Also, a humidifier mechanism (not shown) may be provided in the inner surface of the cover member 60 for humidifying the ink absorber 41.

Both the sealing mechanism S and the closing mechanism T are supported to a common holder 72 fixed to the casing 1 of the inkjet printer. The cap member 40 in the free position is supported to supporting projections 73 made of an elastic material provided around the center of the common holder 72.

The printhead H is located in the wait position WP and the cap member 40 of the sealing member S seals the nozzle surfaces 11a while the inkjet printer is not operated as shown in FIG. 7(a). In this state, the cover member 60 of the closing mechanism T is located in the release position.

The control unit F is adapted to move the cap member 40 away from the nozzle surfaces 11a as shown in FIG. 7(b) in response to a signal generated when the user turns on the main switch (not shown) of the inkjet printer to allow the cap member 40 to rest in the rest position where the cap member is supported to the lower supporting projections 73 thereby moving the printhead H to the home position HP. Further, the control unit F switches the cover member 60 to the closing position where the cap member 40 is closed, as shown in FIG. 7(c). Next, the printing operation is started by the printhead H and the transporting mechanism A. Then, the control unit F moves and stops the printhead H to/at the home position HP as shown in FIG. 7(b) in response to a signal generated when the user turns off the main switch of the inkjet printer or an interruption signal for suspending the printing operation performed over the predetermined time. Next, as shown FIG. 7(b), the cover member 60 is moved away from the cap member 40 first, and the printhead H is moved to the wait position WP, thereby switching the cap member 40 to the sealing position shown in FIG. 7(a).

### Modified Embodiments

(1) In the first embodiment, the cover member 60 of the closing mechanism T is supported to be pivotable about the horizontal axis Xc, and the closing surface 60a located in the release position is directed upward. The closing mechanism T may be arranged otherwise. For example, the closing surface 60a located in the release position may be directed downward, and the cover member 60 may be supported to be slidable upward from the sealing mechanism S. When the closing mechanism T moves to the closing position in such an arrangement, the cover member 60 is slid upward from the sealing mechanism S to move to a position where the closing surface 60a contacts the ink absorber 41 tight. It should be noted that an additional mechanism is required for lowering the cover member 60 or raising the cap member 40 in order to bring the closing surface 60a and the ink absorber 41 in tight contact.

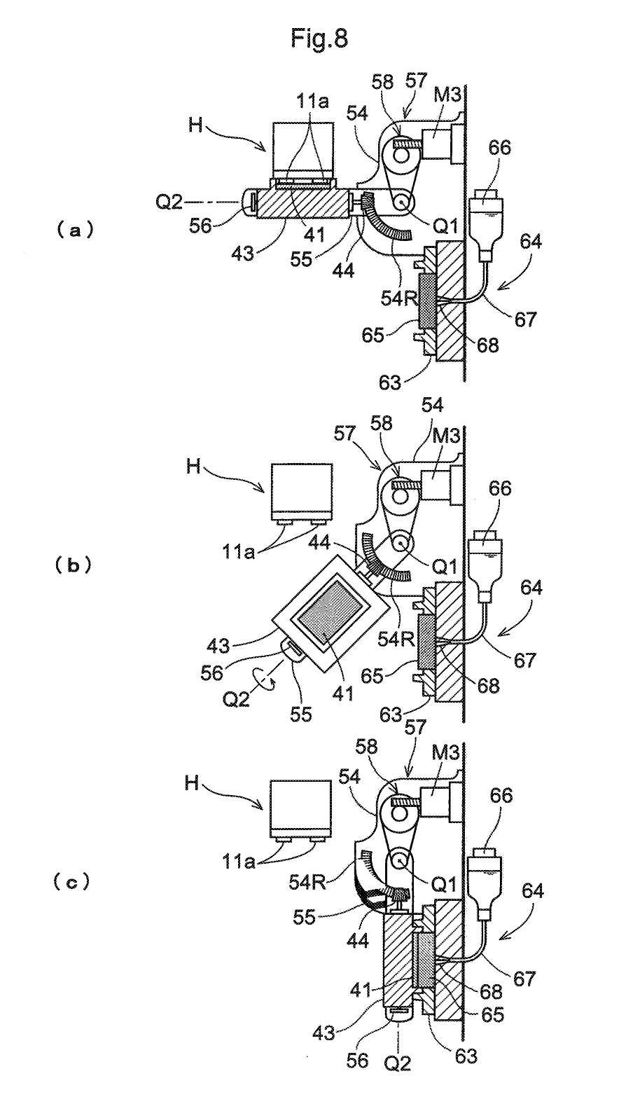

(2) The nozzle surfaces control system may be arranged as shown in FIG. 8. The nozzle surfaces control system shown in FIG. 8 also includes a cap member 43 to be fitted to the nozzle surfaces 11a for sealing the nozzle surfaces 11a from ambient air, and a cover member 63 for closing the opening of the cap member 43 located in the free position. In this case, however, the cover member 63 is fixed to an inner surface of a side wall 1a forming the casing 1. FIG. 8(a) shows a state where the cap member 43 seals the nozzle surfaces 11a, while FIG. 8(b) and FIG. 8(c) show a state where the cap member 43 is moved away from the nozzle surfaces 11a.

The movement operation mechanism 53 for switching the cap member 43 between the sealing position where the cap member 43 is fitted to the nozzle surfaces 11a and the free position where the cap member 43 is moved away from the nozzle surfaces 11a includes a bracket 54 fixed to the inner surface of the side wall 1a of the casing 1, a swing arm 55 supported to be vertically pivotable about a horizontal axis Q1 located on the bracket 54, a supporting mechanism 56 for pivotably supporting the cap member 43 to be pivotable about the cap member 43 about an axis Q2 located along a longitudinal direction of the swing arm 55, and a driving mechanism 57 for pivotably moving the swing arm 55.

The driving mechanism 57 includes a motor M3 fixed to the inner surface of the side wall 1a, and a reduction transmission mechanism 58 for transmitting a driving force of the motor M3 to a pinion gear fixed to the swing arm 55.

As a mechanism for rotating the cap member 43 about the axis Q2 in response to the pivotal movement of the swing arm 55 produced by the driving mechanism 57, the pinion gear 44 in the form of a bevel gear is fixed to the cap member 43 while a rack gear 54R in the form of a bevel gear that is constantly meshed with the pinion gear 44 is mounted on the bracket 54.

In the state shown in FIG. 8(a), the swing arm 55 and the cap member 43 assume a horizontal posture in which the opening of the cap member 43 is oriented upward for closing the nozzle surfaces 11a. As shown in FIG. 8(b), the cap member 43 is rotated about the axis Q2 by action of the pinion gear 44 meshed with the rack gear 54R. In the final stage of the pivotal movement produced by the driving mechanism 57 shown in FIG. 8(c), the swing arm 55 and the cap member 43 assumes a vertical posture in which the opening of the cap member 43 is rotated by approximately 180 degrees from the state shown in FIG. 8(a) to oppose to cover member 63 and is brought to the state (closing position) in which the opening is closed by the cover member 63. The cover member 63 is located in the release position in the state shown in FIG. 8(a) and FIG. 8(b) while being in the closing position in the state shown in FIG. 8(c).

The cover member 63 includes a humidifier mechanism 64 for humidifying the ink absorber 41 of the cap member 43. The humidifier mechanism 64 includes a sponge-like flexible porous member 65 arranged on the inner surface of the cover member 63 so as to contact the ink absorber 41 of the cap member 43 in the closing position, and a humidifying liquid feeding mechanism for maintaining the porous member 65 in a humidified condition. The humidifying liquid feeding mechanism may be formed of a tank 66 mounted on an outer surface of the casing 1, a feeding tube 67 extending from a bottom surface of the tank 66, and a number of capillary path 68 extending from the feeding tube 67 into the interior of the porous member 65, for example.

(3) The humidifier mechanism 64 may be provided as an active humidifier mechanism for humidifying the ink absorber 41 when the cap member 43 is brought to the closing position in which the opening of the cap member is closed by the cover member 63. For example, the arrangement may allow at least part of the tank 66 to be provided on the inner surface of the casing 1, in which the cap member 43 or the swing arm 55 lowered by the driving mechanism 57 to the state shown in FIG. 8(c) pushes a flexible wall surface of the tank 66 thereby forcing the humidifying liquid reserved in the tank 66 to be fed to the porous member 65 to humidify the ink absorber 41.

Alternatively, a bellows-type pump that is compressed by a motor may be provided to act as a tank 66 for reserving the humidifying liquid, in which the humidifying liquid is fed from the pump in response to a command from the control unit F.

(4) Although being not shown, the cap member 40 shown in FIG. 7 or the cap member 43 shown in FIG. 8 includes a waste ink discharge mechanism having a pump for drawing the ink absorbed in the ink absorber 41 in the cap member from the back side of the cap member and a waste ink discharge tank for accumulating the drawn ink.

Also, a wiping mechanism that is not shown as well is provided on a side of the cap member 40 shown in FIG. 7 or the cap member 43 shown in FIG. 8, for example, for wiping out extra ink overflowed on the nozzle surfaces 11a at regular intervals.

The present invention is not limited to the constructions noted above, but may be arranged in various ways without departing from the scope of the invention.

What is claimed is:

1. An inkjet printer comprising:
a printhead for allowing ink to be ejected from a nozzle portion to form an image on a recording medium;
a cap member switchable between a sealing position for sealing nozzle surfaces of the nozzle portion and a free position where the cap member is moved away from the nozzle surfaces; and
a closing mechanism for closing an opening of the cap member located in the free position.

2. The inkjet printer as claimed in claim 1, wherein the closing mechanism includes a cover member for closing the opening of the cap member, and a movement operation mechanism for moving the cover member between a closing position where the opening of the cap member is closed and a release position where the opening of the cap member is exposed in response to switching operations of the cap member between the sealing position and the free position.

3. The inkjet printer as claimed in claim 1, wherein the closing mechanism includes a cover member provided in a casing of the inkjet printer, and a movement operation mechanism for moving the cap member between a closing position where the opening of the cap member is closed by the cover member and a release position where the opening of the cap member is exposed in response to switching operations of the cap member between the sealing position and the free position.

4. The inkjet printer as claimed in claim 2, wherein an ink absorber is provided in an inner surface of the cap member, and the cover member has a closing surface to be pressed on the ink absorber.

5. The inkjet printer as claimed in claim 3, wherein an ink absorber is provided in an inner surface of the cap member, and the cover member has a closing surface to be pressed on the ink absorber.

6. The inkjet printer as claimed in claim 4, wherein a humidifier mechanism is provided in an inner surface of the cover member for humidifying the ink absorber.

7. The inkjet printer as claimed in claim 5, wherein a humidifier mechanism is provided in an inner surface of the cover member for humidifying the ink absorber.
